(19) United States
(12) Patent Application Publication
(10) Pub. No.: US 2026/0020562 A1
(43) Pub. Date: Jan. 22, 2026

(54) USE OF AMINO ACID PEPTIDE SOLUTION PRODUCED BY DECOMPOSITION OF FISH SCALE USING BACILLUS VELEZENSIS FOR HEALTHY AND STRONG GROWTH OF ASTERACEAE SEEDLING AND GROWTH PROMOTION OF ASTERACEAE

(71) Applicant: CH BIOTECH R&D CO., LTD., NANTOU COUNTY (TW)

(72) Inventors: HUI-LIANG WANG, NANTOU COUNTY (TW); YA-FANG HONG, NANTOU COUNTY (TW); CHIAO-FANG HSU, NANTOU COUNTY (TW)

(21) Appl. No.: 18/777,220

(22) Filed: Jul. 18, 2024

(51) Int. Cl. A01N 37/46; A01C 1/00

(52) U.S. Cl. CPC A01N 37/46; A01C 1/00

(57) ABSTRACT

A use of an amino acid peptide solution produced by decomposition of fish scales using Bacillus velezensis for healthy and strong growth of Asteraceae seedlings and growth promotion of Asteraceae plants is provided. The Bacillus velezensis is deposited in Leibniz Institute DSMZ-German Collection of Microorganisms and Cell Cultures GmbH with an accession number of DSM 34894. The Bacillus velezensis is used to decompose fish scales and produce an amino acid peptide solution containing peptides and amino acids. The amino acid peptide solution can make the Asteraceae seedlings grow healthy and strong and promote growth of the Asteraceae plants effectively and specifically.

### BACKGROUND OF THE INVENTION

### Sequence Listing Incorporated by Reference

The Sequence Listing written in file “957-3534-SEQUENCE LISTING-JUL18-2024.xml” created on Jul. 15, 2024 with modification date Jul. 18, 2024, file size 3,453 bytes, is hereby incorporated by reference in its entirety for all purposes.

### FIELD OF THE INVENTION

The present invention relates to a use of an amino acid peptide solution, especially to a use of an amino acid peptide solution produced by decomposition of fish scales using Bacillus velezensis for healthy and strong growth of Asteraceae seedlings and growth promotion of Asteraceae plants.

### DESCRIPTION OF RELATED ART

Most species of family Asteraceae are non-toxic and edible, i.e., aster leaves such as garland chrysanthemum and lettuce, aster roots such as edible burdock, and aster flowers such as chamomile and chrysanthemum. Leaf lettuce is a common leaf vegetable, and above-ground part is economic yield. The higher the yield, the higher the income. In the United States, lettuce is the most widely used leafy green in salads or sandwiches. According to statistics from the U.S. department of agriculture in 2022, lettuce accounted for nearly one-fifth of the $21.8 billion US. growers received in cash receipts from sales of vegetables and melons. There are four types of lettuce, including leaf (bunching) lettuce, romaine lettuce, green-leaf lettuce, and head lettuce. The leaf lettuce can be grown all year long, and it takes about 30-45 days from planting to field to harvest. The romaine lettuce (semi-head lettuce) and green-leaf lettuce (loose leaf lettuce) are typically not considered to be heat tolerant and the optimal cultivation temperature is 15-25° C., so that they should be grown in winter and the cultivation time is longer, ranging from 35-70 days. Once the cultivation time can be shortened, revenue per unit area can be increased. Moreover, grade A lettuce has a normal plant type, leaves in perfect shape, and good color. The larger the plant, the better the specification.

Fish scales were usually discarded as waste in the past. Recently, research related to the fish scales has reported that the fish scales contain about 50% collagen, most of which is produced into collagen peptides by enzymatic hydrolysis, and the collagen peptides are broadly applied to skincare products and health supplements. The fish scales are rarely used as fertilizers to promote the growth of crops.

As to other fertilizers related to collagen, refer to Chinese Pat. Pub. No. 109890781A which provides an amino acid fertilizer composition prepared by treating livestock farming by-products (such as cowhide, pigskin, or cow bones) with acid, alkali, or protease to give crude collagen peptides and then hydrolyzing the crude peptides with Bacillus species. Thereby, a fertilizer composed of crude collagen peptides and amino acids is obtained. Although the fertilizer composition facilitates the growth of lettuces, the use of livestock farming by-products may cause zoonoses such as bovine spongiform encephalopathy (BSE). Compared with the fertilizer from livestock by-products, fish-based fertilizers have a lower risk of contamination and zoonoses.

Most fish-based fertilizers available on the market are produced from composite fish materials, including fish skin, fish bone, fish paste, fish powder, and recovered protein from surimi wash water. During manufacturing process, mixed strains such as yeast, lactic acid bacteria, Bacillus amyloliquefaciens, and Lactobacillus acidophilus are used. Thus, the manufacturing process is more complicated. Symbiosis Agx (American brand) is a fertilizer derived from whole freshwater fish while Aminoterra® is derived from enzymatic hydrolysis of salmon. Compared with products obtained by simple hydrolysis of fish scales, composite fish materials may lead to inconsistent quality of fertilizer products and poor reproducibility of effect due to different sources and ratios of raw materials.

The lettuce has a short growth period and a fast growth rate. In order to increase nutrient uptake efficiency, active fertilizer is applied not only subsoil or in-line fertilization but also after planting for 5-7 days, sprayed every 10-14 days thereafter, and sprayed 2-3 times during the growth period. When too much fertilizer is applied and nutrient solutions are sprayed, the ball lettuce is tilted and inglorious. Moreover, tip-burn occurs easily when too much nitrogen fertilizer is applied combined with high temperature.

Thus, there is room for improvement, and there is a need to find a novel way to overcome shortcomings generated during fertilization of lettuce now.

### SUMMARY OF THE INVENTION

Therefore, it is a primary object of the present invention to provide a use of an amino acid peptide solution produced by decomposition of fish scales using Bacillus velezensis for healthy and strong growth of Asteraceae seedlings and growth promotion of Asteraceae plants. Bacillus velezensis is used to decompose fish scales and produce an amino acid peptide solution containing peptides and amino acids. The amino acid peptide solution is applied to the Asteraceae so that not only seedlings of the Asteraceae family grow stronger and healthier, but growth of above ground part of the Asteraceae is promoted, harvest time is also shortened, and chlorophyll content is increased. Moreover, the Asteraceae will not have fertilizer burn easily, healthy and strong growth of the seedlings and growth promotion of the Asteraceae are achieved. These all help improve yield and field management of the Asteraceae.

In order to achieve the above objects, a use of an amino acid peptide solution produced by decomposition of fish scales using Bacillus velezensis for healthy and strong growth of Asteraceae seedlings and growth promotion of Asteraceae plants is provided. The Bacillus velezensis is deposited in Leibniz Institute DSMZ-German Collection of Microorganisms and Cell Cultures GmbH with an accession number of DSM 34894. The fish-scale amino acid peptide solution obtained by decomposition of a fish scale material using a bacterial solution containing the Bacillus velezensis can help the Asteraceae seedlings grow healthy and strong and promote growth of the Asteraceae seedlings. The fish-scale amino acid peptide solution contains peptides and amino acids.

In some embodiments, a concentration of the peptides and amino acids in the fish-scale amino acid peptide solution is ranging from 50 ppm to 250 ppm.

In some embodiments, a concentration of the peptides and amino acids in the above fish-scale amino acid peptide solution is 100 ppm.

In some embodiments, the Asteraceae mentioned above includes head lettuce, romaine (cos) lettuce, leaf (bunching) lettuce, Gynura bicolor, Gynura divaricata, and greater burdock.

The fish-scale amino acid peptide solution according to the present invention has the following advantages. By spraying fish-scale amino acid peptide solution on leaf surfaces of Asteraceae, not only seedlings of the Asteraceae family grow stronger and healthier, but growth of above ground part of the Asteraceae is promoted, harvest time is also shortened, and chlorophyll content is increased. Moreover, the Asteraceae will not have fertilizer burn easily, healthy and strong growth of the seedlings and growth promotion of the Asteraceae are achieved. These all help improve yield and field management of the Asteraceae.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The structure and the technical means adopted by the present invention to achieve the above and other objects can be the best understood by referring to the following detailed description of the preferred embodiments and the accompanying drawings, wherein:

FIG. 1 are photos showing observation of a colony of strain CHB200 and observation of the strain CHB200 with a microscope according to the present invention;

FIG. 2 is a figure showing analysis of contents of amino acids and peptides in decomposing products of fish scales by strain CHB200 according to the present invention;

FIG. 3 are photos showing products obtained at different stages of large scale fermentation of fish scales by strain CHB200 according to the present invention;

FIG. 4 are photos showing growth of lettuce seedlings in control and treatment groups at day 28 after the lettuce seedlings were respectively sprayed with water (the control group) and 100 ppm fish-scale amino acid peptide solution twice on leaf surfaces and grown with sufficient light and water supply according to the present invention;

FIG. 5 are bar charts showing number of leaves (A) and average chlorophyll content of the 9th, 10th, and 11th leaves (B) of lettuce seedlings respectively sprayed with water (the control group) and 100 ppm fish-scale amino acid peptide solution twice on leaf surfaces; the number of test samples is 8 (n=8) (*p<0.05; ** p<0.01; *** p<0.001) according to the present invention;

FIG. 6 are bar charts showing average leaf length (A) and leaf width (B) of the 9th, 10th, and 11th leaves of lettuce seedlings respectively sprayed with water (the control group) and 100 ppm fish-scale amino acid peptide solution twice on leaf surfaces; the number of test samples is 8 (n=8) (*p<0.05; ** p<0.01; *** p<0.001) according to the present invention;

FIG. 7 are bar charts showing fresh weight (A) and dry weight (B) of above ground part of lettuce seedlings respectively sprayed with water (the control group) and 100 ppm fish-scale amino acid peptide solution twice on leaf surfaces; the number of test samples is 8 (n=8) (*p<0.05; ** p<0.01; *** p<0.001) according to the present invention.

### DETAILED DESCRIPTION OF THE PREFERRED EMBODIMENT

A use of an amino acid peptide solution produced by decomposition of fish scales using Bacillus velezensis to promote growth and keep seedlings of the Asteraceae healthy and strong is provided. A bacterial solution containing the Bacillus velezensis is mixed with a fish scale material to form a mixed solution. After the fish scale material is decomposed by fermentation of Bacillus velezensis in the bacterial solution, a fish-scale amino acid peptide solution containing peptides and amino acids is obtained. The fish-scale amino acid peptide solution is sprayed on leaf surfaces of seedlings of the Asteraceae to help the Asteraceae seedlings grow healthy and strong and promote the growth of the Asteraceae seedlings effectively and specifically. The amount of above-ground biomass is also increased. The Bacillus velezensis is deposited in Leibniz Institute DSMZ-German Collection of Microorganisms and Cell Cultures GmbH with an accession number of DSM 34894.

16S rRNA of the present Bacillus velezensis strain has 98% similarity with 16S rRNA of type strain (standard strain) of Bacillus velezensis B268 with an accession number of CP053764.1. This standard strain is not disclosed to have fish scale decomposing ability.

The mixed solution is fermented at 30-45° C. for 12˜20 hours. The mixed solution includes contains 7-10% (w/v) the bacterial solution of Bacillus velezensis, 15-40% (w/v) the fish scale material, 0.12% (w/v) buffer salts, and the rest percentage of pure water.

After steam sterilization, removal of debris by centrifugation, filtration, and concentrated, a clear and concentrated fish-scale amino acid peptide solution is obtained. Total amount of peptides and amino acids in the fish-scale amino acid peptide solution is measured by o-Phthaldialdehyde (OPA) test reagent and total concentration of the peptides and the amino acids is 30,000 ppm.

In a preferred embodiment, the fish scale material includes fish scales, sodium chloride (NaCl), potassium diphosphate (K₂HPO₄), and monopotassium phosphate (KH₂PO₄).

In a preferred embodiment, the fish scale material includes fish scales, 0.5 g/L of sodium chloride (NaCl), 0.3 g/L of dipotassium phosphate (K₂HPO₄), and 0.4 g/L of monopotassium phosphate (KH₂PO₄).

The strain CHB200 of Bacillus velezensis is obtained from waste chicken feathers. As to techniques for separating and screening strain CHB200 of Bacillus velezensis, please refer to U.S. patent application Ser. Nos. 18/760,688 and 18/772,775 filed on Jul. 1, 2024, and Jul. 15, 2024, respectively.

Moreover, as to test content of fish scale fermentation ability of the strain CHB200, please refer to U.S. patent application Ser. Nos. 18/760,688 and 18/772,775 filed on Jul. 1, 2024, and Jul. 15, 2024, respectively.

In order to learn functions and features of the present invention more completely and clearly, please refer to the following detailed descriptions and related figures. Yet the following embodiments are not intended to limit the scope of the present invention.

<Isolation and Screening of Bacillus velezensis Strain CHB200>

Collect waste chicken feather. After washing, place 5 g of feathers into a conical flask and add 50 mL of sterile water to get a culture medium. Place the culture medium in a 37° C. incubator and culture overnight with a shaking speed at 200 rpm. Then, remove the feather from the culture medium and centrifuge the culture medium. Remove supernatant and retain precipitate after centrifugation. Next, dissolve the precipitate with 100 μL of sterile water and take and spread 20 μL of dissolved solution evenly on Lysogeny broth (LB) solid medium. Incubate the LB solid medium in the 37° C. incubator for 24 hours.

Pick a single colony grown on the LB solid medium, inoculate the colony in 3 ml of LB broth, and culture at 37° C. with a shaking speed at 200 rpm for 24 hours to get a bacterial solution.

Measure absorbance of the bacteria solution at a wavelength of 600 nm (known as OD (optical density) 600). Inoculate the bacterial solution with OD₆₀₀ of 10 therein into 100 mL of M3 fermentation medium containing 33% fish scale powder and ferment at 37° C. for 48 hours. Then, perform hydrolysis test of fish scales. A concentration of the above bacterial solution with OD₆₀₀ of 10 is roughly 1×10⁹ CFU/mL and a composition of the M3 fermentation medium is shown in Table 1. Lastly, measure total concentration of amino acids in fermented solution to screen out a strain with fish scale decomposition ability.

TABLE 1

| | composition | concentration (g/L) |
|---|---|---|
| substrate | fish scale | 330 |
| salts and buffer | NaCl | 0.5 |
| | K₂HPO₄ | 0.3 |
| | KH₂PO₄ | 0.4 |

A method of testing total concentration of amino acids is described briefly below.

Dissolve leucine in double-distilled water and prepare amino acid standard solutions with concentrations of 100-2000 ppm by serial dilution. Take 3 μL of amino acid standard solution or test sample (fermented solution), add 87 μL of ninhydrin reagent, and mix evenly to get an intermediate mixture. The ninhydrin reagent includes 0.6% ninhydrin.

The intermediate mixture is reacted at 100° C. for 10 minutes. After cooling down to room temperature naturally, add 150 μL of 95% alcohol, and mix evenly to get a final mixed solution. Measure absorbance of the final mixed solution at the wavelength of 570 nm (OD₅₇₀). Lastly, make a standard curve by absorbance of a set of the amino acid standard solutions obtained. Then total concentration of amino acids in the test sample is calculated based on the standard curve.

Among the strains tested, a strain capable of decomposing fish scales is obtained and named as strain CHB200.

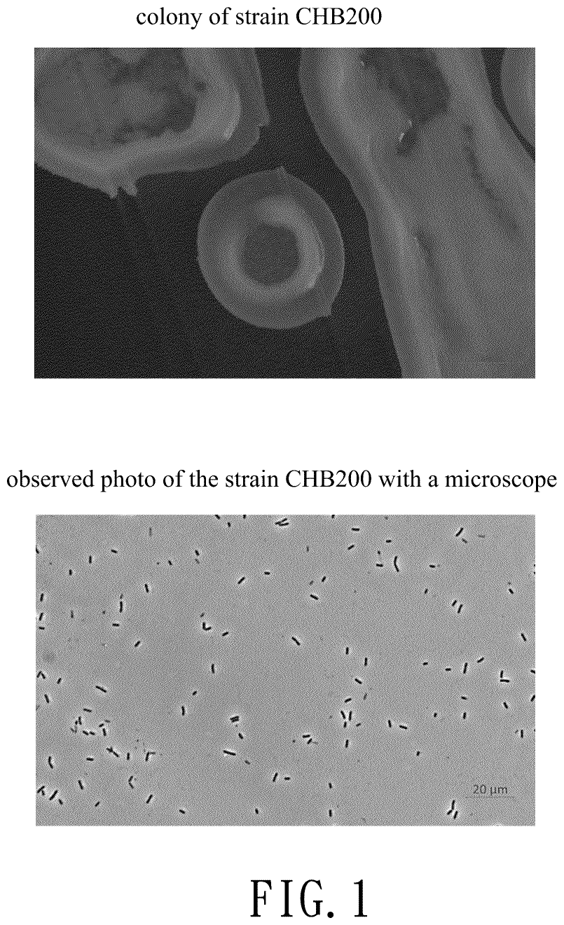

Refer to FIG. 1, a colony of the strain CHB200 is irregular round and transparent to white colored. While being observed under a microscope, the strain CHB200 is a rod with two blunt round ends. Compare 16S rRNA sequence of the strain CHB200 with sequence in Genbank database and the result shows that the strain CHB200 and the Bacillus velezensis B268 have 98% similarity in 16S rRNA sequence. 16S rRNA of the strain CHB200 is disclosed in SEQ ID NO:1 of sequence listing.

### <Test of Fish Scale Fermentation Ability of the Strain CHB200>

Inoculate the strain CHB200 into 3 ml of LB broth and culture at 37° C. with shaking at 200 rpm for 24 hours to get a bacterial solution. Then, take and inoculate the bacterial solution with OD₆₀₀ of 10, therein into 100 mL of M3 fermentation medium containing 33% fish scale powder and ferment at 37° C. to get a fermentation broth. Measure total concentration of peptides and amino acids in the fermentation broth before fermentation (0 hour) and after fermentation for 16 hrs, 24 hrs, 40 hrs, and 48 hrs. The concentration of peptides and amino acids minus the concentration of amino acids leaves the concentration of peptides.

A method of measuring total concentration of amino acids used in the test is the same as the above method using ninhydrin reagent. A method of measuring total concentration of peptides and amino acids used is using o-Phthaldialdehyde (OPA) and described briefly below.

First, prepare Leucine standard solutions. Take and add 10 μL of Leucine standard solutions and test samples respectively into wells of a 96-well plate. Then, add 100 μL of OPA solution into the standard solutions, and the samples and immediately measure absorbance of the standard solutions and the samples at the wavelength of 340 nm (OD₃₄₀). Next make a standard curve by absorbance of the standard solutions obtained, and calculate total concentration of peptides and amino acids in the respective samples tested according to the standard curve. The result obtained by the OPA method minus the total concentration of amino acids obtained by the ninhydrin reagent method leaves total concentration of peptides in the sample tested.

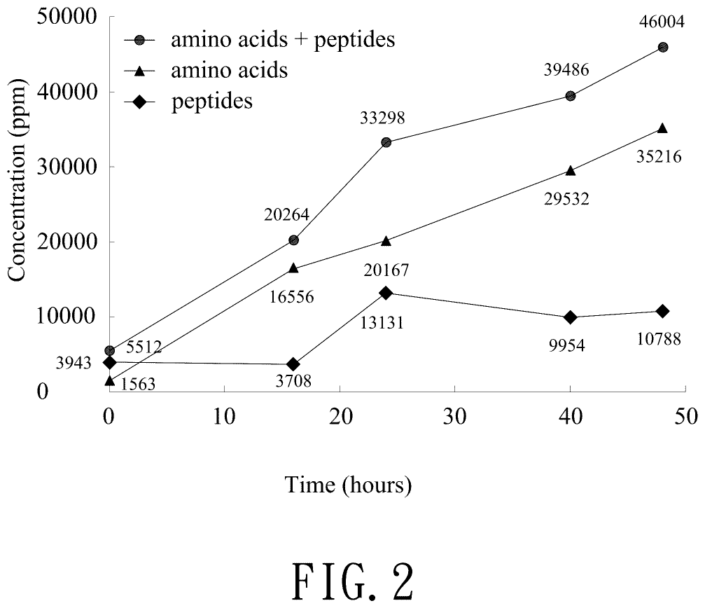

Refer to FIG. 2 and Table 2, the total concentration of amino acids and peptides in the fermentation broth is indeed increased significantly along with the increased fermentation time.

TABLE 2

| | 0 hr | 16 hrs | 24 hrs | 40 hrs | 48 hrs |
|---|---|---|---|---|---|
| total concentration of amino | 5512 | 20264 | 33298 | 39486 | 46004 |
| acids and peptides (ppm) | | | | | |
| total concentration of amino | 1569 | 16556 | 20167 | 29532 | 35216 |
| acids (ppm) | | | | | |
| total concentration of | 3943 | 3708 | 13131 | 9954 | 10788 |
| peptides (ppm) | | | | | |

### <Large Scale Fermentation of Fish Scales by the Strain CHB200>

First, activate the strain CHB200 to get a bacterial solution. Inoculate the bacterial solution in LB broth, adjust final volume to 100 mL, and incubate at 37° C. with shaking for about 16 hours to get a saturated bacterial solution. Pour the saturated bacterial solution into a 10 L fermenter and continuously incubate at 37° C. with shaking for about 2-4 hours until OD₆₀₀ of the bacterial solution reaches 4.0. Then, pour the bacterial solution with OD₆₀₀ of 4.0 into a 100-1000 L fermenter and incubate at 37° C. with shaking for about 2-4 hours until OD₆₀₀ reaches 4.0 to obtain a fermented bacterial solution.

Washed and cleaned fish scale material is placed into a 100 L-10 T fermenter, and then add buffer salts and pure water to get a M3 fermentation broth containing fish scale material. Then the M3 fermentation broth is placed under 121° C. and 1.5 atm to be sterilized for 30 minutes. The sterilized M3 fermentation broth is cooled down to 30-45° C. and added with the above fermented bacterial solution to get a fermentation broth. The fermentation broth is fermented at 37° C. and stirred continuously for introduction of air. The fermentation time is 12-24 hours to obtain a primary product of fermentation. A composition of the above fermentation broth contains 7-10% (w/v) fermented bacterial solution, 15-40% (w/v) fish scale material, 0.12% (w/v) buffer salts, and the rest percentage of pure water. The preferred ratio of the fish scale material in the fermentation broth is 20-35% (w/v) and the preferred fermentation time is 16-20 hours. The composition of the M3 fermentation broth is shown in Table 1.

The primary product of fermentation is centrifuged at 3000-5000 rpm or 9000-11000 rpm by a decanter centrifuge or tubular centrifuge. Keep supernatant to obtain a debris-free fermentation broth.

Then, the debris-free fermentation broth is centrifuged at 9000-12000 rpm or 9000-11000 rpm by a disc centrifuge or a tubular centrifuge. Remove bacteria sedimentation to get a clear fermentation broth and measure total concentration of amino acids, total concentration of peptides, and nitrogen content of the clear fermentation broth.

Next, the clear fermentation broth is concentrated at 45-55° C. by a vacuum low temperature evaporator for 3-6 hours to get a concentrated fermentation broth. And measure total concentration of amino acids, total concentration of peptides, and nitrogen content of the concentrated fermentation broth.

Methods of measuring the total concentration of amino acids and peptides are as shown in the above paragraphs related to the isolation and screening of Bacillus velezensis strain CHB200 and the test of fish scale fermentation ability of the strain CHB200 mentioned above, while a method of measuring nitrogen content is described briefly below.

Mount a homogeneous test sample into a tin foil capsule and add silicon dioxide (SiO₂) as an adsorbent. The capsule is sealed into a cylinder or a cube. Then, use an elemental analyzer (Flash 2000, Thermo Fisher Scientific) to measure nitrogen and carbon contents in the test sample. Moreover, protein content in the test sample can be estimated by multiplying the nitrogen content by a factor of 6.25 since the average nitrogen content of proteins is found to be about 16 percent.

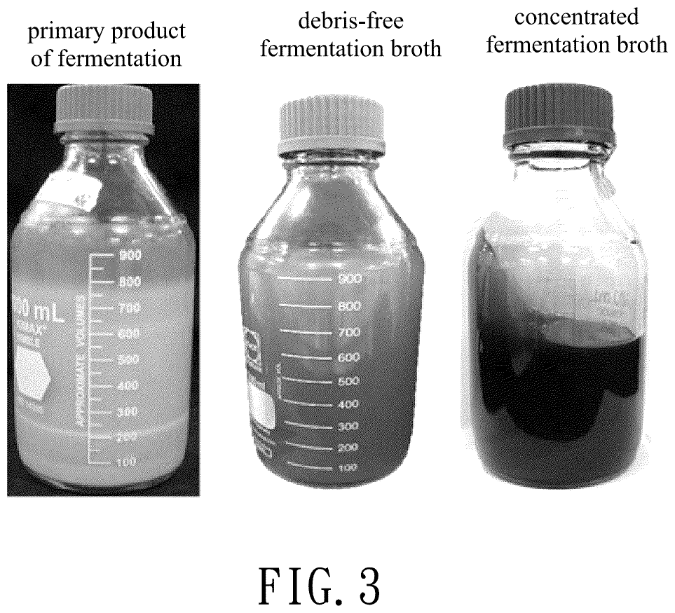

A composition analysis of the clear fermentation broth is performed by SGS Certification Taiwan, and total concentration of peptides and amino acids in the clear fermentation broth are respectively 28164 ppm and 73080 ppm, while nitrogen content and protein content in the clear fermentation broth are respectively 1.7% and 10.56%. In the concentrated fermentation broth, total concentration of peptides and amino acids are respectively 120510 ppm and 365015 ppm, while nitrogen content and protein content are respectively 6.9% and 43.125%. Refer to FIG. 3, photos of the primary product of fermentation (with debris), the debris-free fermentation broth, and the concentrated fermentation broth are provided.

According to the above test results, it is learned that the strain CHB200 of the Bacillus velezensis capable of decomposing fish scales is having good fish scale decomposing ability, and able to be applied to large-scale fermentation due to the effective decomposition of fish scales within a short period of time. Thus, the strain CHB200 has potential for industrial applications. Moreover, the fermentation broth obtained is rich in amino acids and peptides and thus able to be applied to agricultural fertilizer for growth promotion and healthy and strong growth of the Asteraceae seedlings.

In a preferred embodiment, the Asteraceae mentioned above includes head lettuce, romaine (cos) lettuce, leaf (bunching) lettuce, Gynura bicolor, Gynura divaricata, and greater burdock.

A fermentation broth obtained by decomposition of fish scale material using the strain CHB200 is further used for preparation of a fish-scale amino acid peptide solution which is applied to Asteraceae seedlings. The following are tests for showing healthy and strong growth and growth promotion of the Asteraceae seedlings by the fish-scale amino acid peptide solution. The concentration of the peptides and the amino acids in the fish-scale amino acid peptide solution is 50-250 ppm, while 100 ppm is preferred. In the following tests, lettuces of the Asteraceae family are test subjects and the concentration of the peptides and the amino acids in the fish-scale amino acid peptide solution being sprayed on leaf surfaces of the lettuce is 100 ppm.

### Experiment Material and Method

The fermentation broth is diluted with water to get a fish-scale amino acid peptide solution in which a total concentration of amino acids and peptides is 100 ppm.

Lettuce seeds used are seeds of Romaine lettuce (LS-003) from Known-You Seed Co., Ltd. with smaller size and lower germination rate. Planting medium used is peat soil (GRAMOFLOR) and vermiculite (south sea vermiculite No. 2, fine diameter) in a ratio of 3:1. The daytime/nighttime temperature of a growth environment is set at 26/24° C. with 16 hours of daylight and 8 hours of darkness. 7 days after sowing, screen out 8 seedlings with uniform growth for both the control group and the treatment group. The leaf surfaces of the seedlings of lettuce are respectively applied with water (control group) and 100 ppm fish-scale amino acid peptide solution (treatment group) at day 14 and day 21 after sowing. The amount of liquid (water or fish-scale amino acid peptide solution) applied at day 14 and at day 21 is respectively 0.5 ml and 1 ml per seedling. At day 28 after sowing, analyze physiological data such as the number of leaves of the lettuce seedling, average leaf length, leaf width, and average leaf chlorophyll content measured by SPAD 502 Plus (Spectrum technologies Inc.) of the 9th, 10th, and 11th leaves of the lettuce seedlings, fresh weight, and dry weight of the lettuce seedlings of both the control group and the treatment group. The data is analyzed by Student's t-test function in Excel. The number of the test samples is 8 (n=8) (*p<0.05; ** p<0.01; *** p<0.001).

### Experiment Results

With sufficient light and water, observe and take photos of the lettuce seedlings to record growth of the lettuce seedlings respectively sprayed with water (control group) and 100 ppm fish-scale amino acid peptide solution (treatment group) every day.

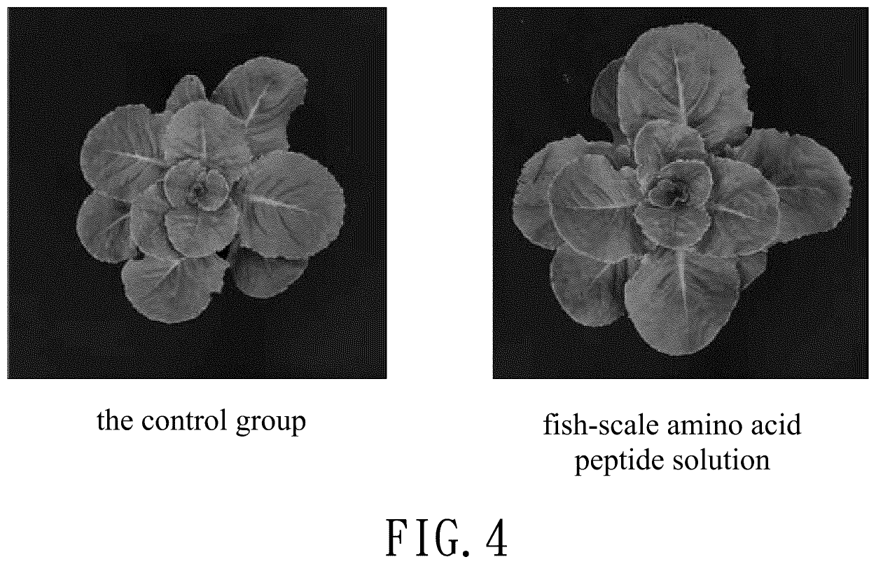

FIG. 4 is a photo (the number of the test samples is 8) showing growth of the lettuce seedlings in the control group and the treatment group at day 28. Refer to the photo shown in FIG. 4, it is learned that under conditions with sufficient light and water, the lettuce seedling sprayed with the fish-scale amino acid peptide solution on leaf surfaces twice obviously has more leaves, longer leaf length, and larger leaf width compared with the lettuce seedling sprayed with water on leaf surfaces twice.

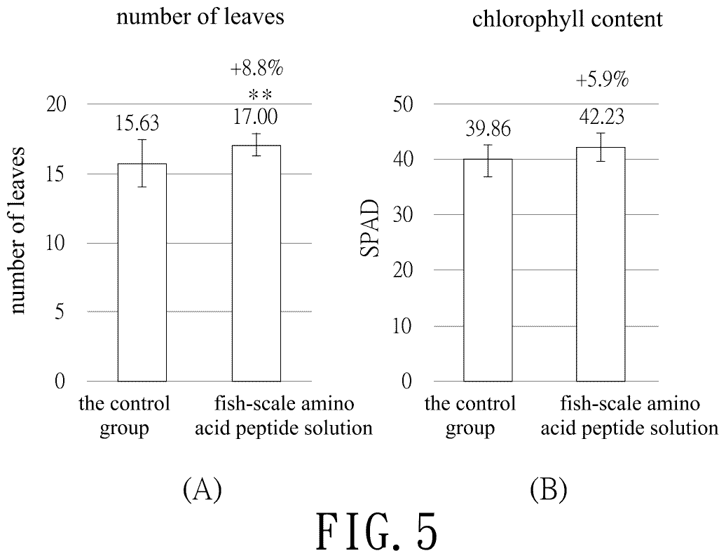

Compared with the lettuce seedling sprayed with water on its leaf surface, the number of the leaves of the lettuce seedling sprayed with the fish-scale amino acid peptide solution twice on its leaf surface increased by 8.8% (refer to FIG. 5A). The number of the test samples is 8 (n=10) (*p<0.05; ** p<0.01; *** p<0.001).

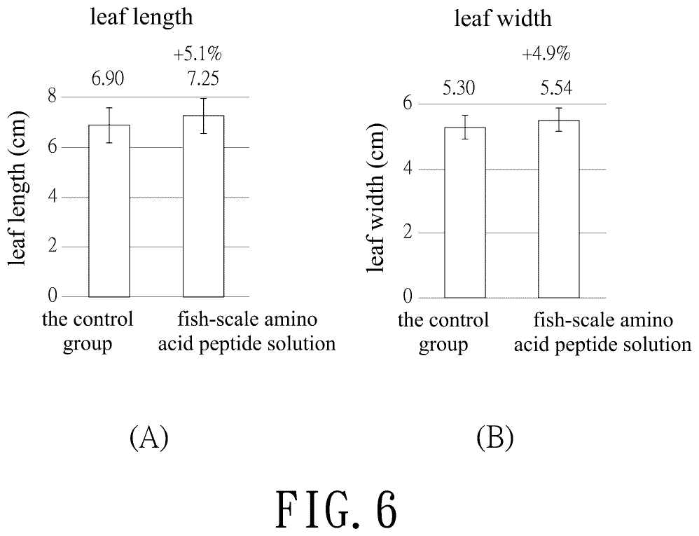

Moreover, make a comparison of average leaf length, average leaf width, and average chlorophyll content of the 9th, 10th, and 11th leaves of the lettuce seedlings respectively sprayed with 100 ppm fish-scale amino acid peptide solution and water twice on leaf surfaces. The average leaf length of the 9th, 10th, and 11th leaves of the lettuce seedlings sprayed with 100 ppm fish-scale amino acid peptide solution twice is 5.1% larger than that of the lettuce seedlings sprayed with water (as shown in FIG. 6A). The average leaf width of the 9th, 10th, and 11th leaves of the lettuce seedlings sprayed with 100 ppm fish-scale amino acid peptide solution twice is 4.9% larger than that of the lettuce seedlings sprayed with water (as shown in FIG. 6B). The average chlorophyll content of the 9^{th}, 10^{th}, and 11^{th} leaves of the lettuce seedlings sprayed with 100 ppm fish-scale amino acid peptide solution twice is 5.9% larger than that of the leaves of the lettuce seedlings sprayed with water (as shown in FIG. 5B). The number of the test samples is 8 (n=8) (*p<0.05; ** p<0.01; *** p<0.001).

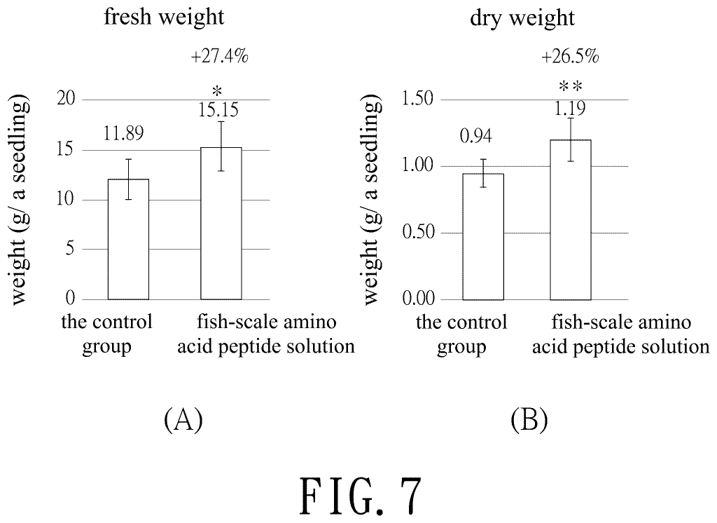

After taking photos on day 28, the above-ground part of the lettuce is harvested, and above ground fresh biomass is weighted by Shimadzu AP224X analytical balance. Then the above ground fresh biomass is placed and dried in a large type of hot air circulation oven (LENON, CO-3). Use the analytical balance to weight above ground dry biomass. The related test data is processed and analyzed with Microsoft Office Excel software tool. Compared with the lettuce seedlings sprayed with water on the leaf surface, the fresh weight and the dry weight of the above ground part of the lettuce seedlings sprayed with the fish-scale amino acid peptide solution twice on the leaf surfaces are respectively increased by 27.4% (refer to FIG. 7A) and 26.5% (refer to FIG. 7B). The number of the test samples is 8 (n=8) (*p<0.05; ** p<0.01; *** p<0.001).

According to the above results, it is learned that the fish-scale amino acid peptide solution obtained by decomposition of fish scales using Bacillus velezensis as described in the present invention, facilitates the growth of lettuce seedlings. Compared with the control group, the number of leaves, the leaf length, the leaf width, the chlorophyll content, the fresh weight, and the dry weight of the treatment group are respectively increased by 8.8%, 5.1%, 4.9%, 5.9%, 27.4%, and 26.5%.

During the tests, the lettuce seedlings whose leaf surfaces are applied with the scale amino acid peptide solutions having different concentrations all show no phytotoxicity.

Therefore, based on the above results, the fish-scale amino acid peptide solution obtained by decomposition of fish scales using Bacillus velezensis and applied to the leaf surfaces of the Asteraceae not only makes the Asteraceae seedlings grow stronger and healthier and promotes seedling growth of the Asteraceae, but also helps improve field management and yield of the Asteraceae.

Additional advantages and modifications will readily occur to those skilled in the art. Therefore, the invention, in its broader aspects, is not limited to the specific details and representative devices shown and described herein. Accordingly, various modifications may be made without departing from the spirit or scope of the general inventive concept as defined by the appended claims and their equivalent.

What is claimed is:

1. A use of an amino acid peptide solution produced by the decomposition of fish scales using Bacillus velezensis for healthy and strong growth of Asteraceae seedlings is provided; the Bacillus velezensis is deposited in Leibniz Institute DSMZ-German Collection of Microorganisms and Cell Cultures GmbH with an accession number of DSM 34894; the fish-scale amino acid peptide solution obtained by decomposition of a fish-scale material using a bacterial solution containing the Bacillus velezensis is able to make the Asteraceae seedlings grow healthy and strong effectively and specifically; the fish-scale amino acid peptide solution contains peptides and amino acids.

2. The use as claimed in claim 1, wherein a concentration of the peptides and amino acids in the fish-scale amino acid peptide solution is ranging from 50 ppm to 250 ppm.

3. The use as claimed in claim 2, wherein the concentration of the peptides and amino acids in the fish-scale amino acid peptide solution is 100 ppm.

4. The use as claimed in claim 3, wherein the Asteraceae includes head lettuce, romaine lettuce, leaf lettuce, Gynura bicolor, Gynura divaricata, and greater burdock.

5. The use as claimed in claim 4, wherein the Asteraceae is lettuce.

6. The use as claimed in claim 2, wherein the Asteraceae includes head lettuce, romaine lettuce, leaf lettuce, Gynura bicolor, Gynura divaricata, and greater burdock.

7. The use as claimed in claim 6, wherein the Asteraceae is lettuce.

8. The use as claimed in claim 1, wherein the Asteraceae includes head lettuce, romaine lettuce, leaf lettuce, Gynura bicolor, Gynura divaricata, and greater burdock.

9. The use as claimed in claim 8, wherein the Asteraceae is lettuce.

10. A use of an amino acid peptide solution produced by decomposition of fish scales using Bacillus velezensis for growth promotion of Asteraceae is provided; the Bacillus velezensis is deposited in Leibniz Institute DSMZ-German Collection of Microorganisms and Cell Cultures GmbH with an accession number of DSM 34894; the fish-scale amino acid peptide solution obtained by decomposition of a fish-scale material using a bacterial solution containing the Bacillus velezensis is able to promote the growth of the Asteraceae effectively and specifically; the fish-scale amino acid peptide solution contains peptides and amino acids.

11. The use as claimed in claim 10, wherein a concentration of the peptides and the amino acids in the fish-scale amino acid peptide solution is ranging from 50 ppm to 250 ppm.

12. The use as claimed in claim 11, wherein the concentration of the peptides and the amino acids in the fish-scale amino acid peptide solution is 100 ppm.

13. The use as claimed in claim 12, wherein the Asteraceae includes head lettuce, romaine lettuce, leaf lettuce, Gynura bicolor, Gynura divaricata, and greater burdock.

14. The use as claimed in claim 13, wherein the Asteraceae is lettuce.

15. The use as claimed in claim 11, wherein the Asteraceae includes head lettuce, romaine lettuce, leaf lettuce, Gynura bicolor, Gynura divaricata, and greater burdock.

16. The use as claimed in claim 15, wherein the Asteraceae is lettuce.

17. The use as claimed in claim 10, wherein the Asteraceae includes head lettuce, romaine lettuce, leaf lettuce, Gynura bicolor, Gynura divaricata, and greater burdock.

18. The use as claimed in claim 17, wherein the Asteraceae is lettuce.


SEQUENCE LISTING (1 sequence)

SEQ ID NO: 1 - RNA, 1502 nt, Bacillus velezensis
  source 1..1502: mol_type = rRNA
gacgaacgctggcggcgtgcctaatacatgcaagtcgagcggacagatgggagcttgctccctgatgttagcggcggacgggtgagtaacacgtgggtaacctgcctgtaagactgggataactccgggaaaccggggctaataccggatggttgtttgaaccgcatggttcagacataaaaggtggcttcggctaccacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgccgttcaaatagggcggcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaacctttatggagccagccgccgaaggtgggacagatgattggggtgaagtcgtaacaaggtagccgtatcggaagg